(19) United States
(12) Patent Application Publication
(10) Pub. No.: US 2010/0009234 A1
(43) Pub. Date: Jan. 14, 2010

(54) METHOD FOR GENERATING A CATALYST LAYER

(75) Inventor: Manfred Stefener, Munich (DE)

Correspondence Address: MYERS WOLIN, LLC, 100 HEADQUARTERS PLAZA, North Tower, 6th Floor, MORRISTOWN, NJ, 07960-6834, US

(73) Assignee: ELCOMAX GMBH, Munich (DE)

(21) Appl. No.: 12/547,713

(22) Filed: Aug. 26, 2009

Related U.S. Application Data
(63) Continuation of application No. PCT/EP2008/001374, filed on Feb. 21, 2008.

(30) Foreign Application Priority Data
Feb. 26, 2007 (DE) 10 2007 009 630.7

(51) Int. Cl. H01M 8/10; B01J 37/34; H01B 1/00

(52) U.S. Cl. 429/30; 502/5; 252/500

(57) ABSTRACT

A method for producing a catalyst layer (1) for fuel cells, chemical or electrochemical reactors using a precursor layer, which comprises a plurality of electrically conductive precursor particles (3, 4), a catalyst (2) being electrochemically deposited, the catalyst layer (1) being produced as a structured layer. This is achieved by the targeted inhomogeneous selection of the precursor particles (3, 4) with regard to at least one particle property, by the addition of non-conductive particles and/or at least one chemical additive to the precursor layer, and/or in that significant amounts of gas are produced in the catalyst layer or conveyed through said layer before, during, or after the electrochemical deposition.

This application is a continuation application of PCT/EP2008/001374, filed Feb. 21, 2008, which claims priority to DE Patent Application 10 2007 009 630.7 filed Feb. 26, 2007, the contents of each of which are incorporated herein by reference in their entireties.

The present invention relates to a method for generating a catalyst layer for fuel cells, for chemical reactors or for electrochemical reactors using a precursor layer, which contains a plurality of electrically conductive precursor particles, wherein a catalyst is electrochemically deposited. The present invention also relates to a catalyst layer produced by this method as well as to a precursor solution or precursor layer intended for use in connection with the inventive method.

Production methods of the class in question and corresponding layers or solutions are already known from EP 0988656 B1 or EP 1307939 B1, both of which are incorporated in full scope as subject matter of the present disclosure. The catalyst layers explained in the cited publications are needed in particular as components of the membrane-electrode unit (Membrane Electrode Assembly—MEA) for fuel cells; in this connection, the structure and functional principle of an MEA and of a fuel cell respectively will be explained briefly hereinafter for more detailed elucidation of the background of the present invention.

An MEA having a structure relevant for the present invention is composed preferably and substantially of an ion-conducting solid electrolyte membrane, especially of a polymer electrolyte membrane, the two sides of which are in contact with one electrode layer each, each of which layers in turn adjoins a (gas) diffusion layer (Gas Diffusion Layer—GDL). The fuel to be converted (such as hydrogen, methanol, etc.) is supplied to the anode side of the MEA through the porous gas diffusion layer. By means of a catalyst deposited in or on the electrode, there is initiated a chemical reaction (oxidation), in which both electrons and ionic components are liberated. The electrons are discharged via the electrodes, whereas the ionic components migrate through the membrane toward the second electrode (cathode). There a renewed chemical reaction (reduction) takes place together with electrons from the cathode and a substance or gas supplied via the second diffusion layer, and the flow of electrons between anode and cathode is captured as electrical energy.

From the principles explained in the foregoing it is clear that optimal fuel conversion takes place in those regions of the MEA in which, on the one hand, catalyst is present and, on the other hand, not only is electrical and ionic conductivity present but also supply and removal of reaction starting materials and reaction products respectively are ensured. Those regions are known as the three-phase zone.

The electrochemical deposition of metal catalyst particles in a precursor layer containing a metal salt, constituting the theme of the cited publications, already permitted a decisive reduction of the costs of producing membrane electrode assemblies for fuel cells, since it was possible to reduce the necessary amount of expensive catalyst material with the respective cited measures. Specifically, the catalyst particles generated electrochemically from catalyst salts exhibit particularly high electrochemical activity, since they are formed during electrochemical deposition only at sites that are in electrical and electrolytic contact simultaneously. Thus deposition advantageously takes place exactly and almost exclusively in parts of the three-phase zone.

In other words: The method of electrochemical deposition makes it possible to deposit the expensive catalyst (such as platinum) only in those regions of the electrode and catalyst layer in which it will be needed later for energy conversion (or for a chemical or electrochemical reaction). Because of the electrochemical deposition, there is therefore achieved a considerable advantage compared with the conventional production of catalyst layers, especially for use in fuel cells, in which simultaneous electrolytic and electrical contact cannot be controlled at all or to the desired extent.

Starting from this point, the object of the present invention is to improve once again the production method of the class in question and the material compositions used for this purpose. In particular, it is intended to ensure an additional savings of catalyst material accompanied by an increase of efficiency of the subsequent energy conversion.

Firstly it is to be mentioned in connection with the present invention that the method claims coordinated with each other serve a uniform inventive concept, to the effect that a structured catalyst layer is generated by specific inhomogeneity in the precursor layer and/or by means of special process steps during application of the method of electrochemical deposition. For this purpose—in all method variants discussed hereinafter—there are preferably formed a coarse and a fine structure, which proves to be particularly expedient both with regard to the media flows in the electrode layer and with regard to the electrical and ionic conductivity.

Furthermore, it is to be mentioned as a prelude that, in connection with a method of the class in question, the presence of electrolyte material in the precursor layer—which is advantageously applied on a substrate—is necessary, specifically for production of the ionic conductivity necessary for electrochemical deposition. Within the scope of the present invention, and in the manner specified in still more detail hereinafter, this electrolyte material either may already be present in the precursor layer or else may be first introduced into the catalyst layer to be deposited during the electrochemical deposition.

The first inventive method variant is characterized—besides the method features already mentioned hereinabove—in that the catalyst layer is generated as a structured layer, by selecting the precursor particles to be specifically inhomogeneous with respect to at least one particle property.

The invention therefore makes use of the knowledge that, by specifically inhomogeneous selection of the electrically conductive precursor particles, there can be generated a structured catalyst layer. In this way the formation and extent of the three-phase zone in the electrode or catalyst layer can be selectively optimized. And, within the scope of the present invention, the catalyst layers produced in such a way can also be optimized with respect to some further aspects, such as the necessary removal of the products generated in the chemical reaction during subsequent fuel conversion. Special configurations and advantages of these inventive method alternatives will be explained in more detail hereinafter together with the advantages of further method variants.

A second inventive method variant provides—besides the method steps cited hereinabove—that the catalyst layer will be generated as a structured layer, by additionally admixing nonconductive particles also with the precursor layer. In a preferred improvement of this method, these can be soaked, doped and/or coated at least partly with electrolyte material. This will also be explained and elaborated in more detail hereinafter.

A third inventive method variant is characterized—besides the method steps cited hereinabove—in that the catalyst layer will be generated as a structured layer, by admixing at least one chemical additive, especially what is known as a chemical complexing agent, with the precursor layer. In this case also, more detailed explanations and preferred method configurations will be presented hereinafter.

And finally, in a fourth inventive method variant it is provided that the catalyst layer will be generated as a structured layer, by generating significant amounts of gas in the catalyst layer or passing such amounts therethrough before, during or after electrochemical deposition of the catalyst material. What is to be understood by a significant amount, and the manner in which, for example, the generation of a corresponding amount of gas can be achieved in the layer, will also become evident from the explanations hereinafter—besides an outline of the advantages of this method variant.

The four method variants cited in the foregoing and claimed separately with inventive structure formation for the catalyst layer either may be applied independently of each other or may be combined with each other in any desired way. However, it is common to all variants that, in connection with the production of a catalyst layer by means of electrochemical deposition during the specifically used method steps for structure formation, there is achieved a previously unknown or unused degree of freedom in optimization of the catalyst layer and its production method.

Concerning the technical background of the invention, the following additional information must be presented first:

It is known in principle that mass transport as well as fluid dynamics in a fuel cell and in other chemical or electrochemical reactors has a decisive influence on the performance thereof. Included therein is the influence of the flow channels of the flow field on the macroscopic equilibrium distribution of the media streams, the influence of the gas diffusion layer on the exact equilibrium distribution of the media over the active area of the catalyst structure, and also the influence of the electrode or catalyst structure on the microscopic flow and reaction behavior.

The smaller the size scale of the structure is, the smaller the influence that heretofore could be exerted on the corresponding structure. In particular, the production of the electrode layer is subject to a large number of boundary conditions, which greatly limit the formation of the three-phase zone or the possible variants for specific structure formation.

In this connection it must be pointed out that the chemical reduction of catalyst particles can be optimized only on a few types of carbon, that a binder, often in the form of the electrolyte, is needed for generation of a solid layer, which binder then also covers part of the catalyst particles, and that now the surface properties desired for suitable fluid dynamics still have to be generated in the supported catalyst of the prior art. These and many other problems lead to suboptimal utilization of the catalyst particles in the prior art, especially in the case of non-electrochemical deposition of the catalyst.

In contrast, the present invention is based on the knowledge among other facts that the inherently known technique of electrochemical deposition from a preliminary or precursor layer offers the possibility of generating catalyst particles from metal salts introduced into the layer only when the desired properties of the layer have been achieved by preceding manufacturing steps. Within the scope of the present invention, this knowledge is utilized for specific structure formation of the catalyst layer.

In this connection it is important firstly to define the term “precursor” or “precursor layer” used in the previous literature more precisely. From the “precursor layer” it is possible—if necessary after later addition of catalyst and/or electrolyte material—to generate catalyst particles by electrochemical deposition. By “precursor” it is then possible to understand a large number of precursor particles, especially in the form of carbon particles, which have been or will be impregnated or intermixed with a solution of metal salts and dissolved electrolyte material. Precursor particles impregnated in this way can be applied in the form of layers on a substrate.

Heretofore, exclusively the use of a substantially uniform carbon material has been described in the literature for production of such a precursor. An optimal electrode or catalyst structure cannot be achieved in this way, however, because the possibilities used for specific structure formation for the first time within the scope of the present invention cannot be exhausted under these circumstances.

The decisive innovation of this invention is therefore the specific structure formation of electrode or catalyst layers, which can be adapted to the respective requirements of fluid dynamics in various types of fuel cells (or in chemical or electrochemical reactors), while using various fuels.

The production of the precursor layer and the subsequent electrochemical deposition therefore become successive steps of the production of such structured electrode layers.

Experiments show that the conductivity of fuel cells depends not only on the pure electrochemical activity but also on the structural properties of the electrodes, such as their thickness, porosity, pore-size distribution, surface properties, etc. In order to be able to benefit particularly effectively from the electrochemical deposition, the already cited measures for specific structure formation of the precursor layer and of the electrode obtained therefrom are therefore provided within the scope of the present invention. In this way the present invention makes use of the advantageous properties of electrochemical deposition, in order to generate optimal electrode layers having improved properties such as porosity, pore-size distribution, surface properties, density and distribution of catalyst particles as well as many more in preceding manufacturing steps. Incidentally, this has the decisive advantage that the quality and functionality of an electrode can be defined and checked before catalyst particles are formed at all from the metal salts normally used. In this way rejects and the entire manufacturing costs can be decisively reduced—while simultaneously improving the quality and functionality of the electrode layer.

Within the scope of the present invention, it is further possible, by specific use of particular precursor particles, to improve the quality of deposition significantly relative to uniform distribution of the catalyst particles and to the size and uniformity of the catalyst particles. This is of decisive importance for the costs of a fuel cell. After all, even though the electrochemical deposition guarantees the generation of electrochemically active catalyst particles, prior art catalyst particles are also formed at locations that are not optimal from the viewpoints of fluid dynamics. This problem can be circumvented with specific structure formation, thus leading to a further distinct reduction of loading with noble metals.

Furthermore, the selection of the materials used for construction of the precursor layer, such as carbon particles, electrolyte material and the metal salts necessary for catalyst deposition, can decisively influence the result of the subsequent electrochemical deposition. For example, catalyst particles are deposited in various distributions and sizes on different carbon supports. In this connection, a uniform distribution is important for accessibility of media to the catalyst particles, and it may lead to enhanced performance. And even the size of the resulting catalyst particles influences the total amount of necessary catalyst material and thus the costs. Ideally, it is intended that preferably a substantially uniform size of the catalyst particles in the range between 1.5 nm and 4 nm will be achieved with the present invention.

The generation of the electrode or catalyst structure according to the present invention therefore comprises various aspects, in which connection the measures provided according to the invention during preparation or production of the precursor layer have, by virtue of the intentionally induced structure formation in the nano and micro range, considerable effects on the subsequent step of electrochemical deposition of the catalyst.

Hereinafter there will first be described individual measures, which are of decisive importance for specific structure formation—especially in connection with the first inventive method variant.

Wherever it is mentioned that the precursor particles present in the precursor layer are specifically selected to be inhomogeneous with respect to at least one particle property, this preferably and advantageously means the surface property of the particle, the particle material, the particle shape and/or the size of the selected precursor particles.

The precursor layer itself is preferably formed on a substrate, by applying at least one precursor solution containing the precursor particles on the substrate.

Aspects to be considered within the scope of the present invention are in particular the wettability of the particles with a precursor solution containing catalyst salts (and consequently the penetration depth, the concentration and thus the size and density of the catalyst particles during and after deposition), the fluid dynamics of the catalyst layer to be produced, in order to permit specific supply and removal of substances, the stability of the carbon particles to degradation and the flow distribution in the catalyst layer during deposition as a function of particle size.

With a specific inhomogeneous selection of precursor particles according to particle material (such as carbon, graphite), size, shape (spherical; fibrous; nanostructured, such as nano tubes, nano coils, nano wires, nano plates, etc.) and/or their surface properties (hydrophilic, hydrophobic, impregnated with Teflon or similar material, graphitic, chemically altered by addition of particular organic or inorganic molecules), the process of electrochemical deposition can be prepared and conducted in such a way that firstly there can be achieved inexpensive impregnation of the precursor layer with catalyst, secondly the deposition leads to a high particle density and to specifically adjustable particle sizes of the deposited catalyst, and thirdly the process can be achieved without post-treatment.

In gas diffusion electrodes that can be produced according to the invention, wherein the gas diffusion layer (GDL) is used as a substrate for the precursor layer, counterflow of starting materials and products of the electrochemical reaction usually occurs. In some cases, even phase changes take place during the reaction (for example, condensation, whereby supply or removal of a liquid phase must be additionally ensured), thus leading to considerable differences in the amounts to be transported and to further problems during mass transport. For example, considerable amounts of liquid can be discharged due to the velocity and pressure of the gas stream, which in some cases may be much stronger, or the gas stream can be impeded by considerable amounts of liquids (a condition known as flooding).

Within the scope of the present invention, it is therefore advantageous to create channels/pores in the catalyst or electrode layer, since they can be adapted in a preferred manner specifically for supplying starting materials or removing products. These properties can be established particularly well by inventive structuring of the catalyst layer. Thus structure properties of a structured catalyst layer are, for example, pore size, pore-size distribution (for example, with two or more different frequency maxima during formation of at least one coarse structure and at least one fine structure), surface properties of the layer (hydrophilic or hydrophobic) or of the materials used (for example, precursor particles from graphited carbon as hydrophobic components).

Within the scope of the present invention, it is particularly preferable to target a layer structure with anisotropically structured materials or two or more different materials, for example by selecting precursor particles having considerably different particle-size distributions (for example, two or more frequency maxima in the size distribution of the precursor particles used for the precursor layer; comparable with a bed of large and small spheres). Particle sizes on the order of approximately 1 to 50 nm (length or diameter; depending on the nature of the particles) are suitable for formation of a fine structure. The coarse structure can be obtained with particles on the order of approximately 40 to 500 nm. In this connection, it is obvious that the particles for formation of the coarse structure must be larger than those for formation of the fine structure. An average size difference of at least 10 nm, advantageously at least 20 nm or even more preferably at least 30 nm is to be targeted in order to form a pore structure of the precursor layer that is desired within the scope of the present invention.

In an advantageous exemplary embodiment of the present invention, the formation of a coarse structure from graphited carbon particles having a size of approximately 50 nm (fibers having a length of approximately 50 nm, or substantially spherical particles with average diameters of approximately 50 nm) as well as hydrophobic properties is targeted, accompanied by simultaneous formation of a fine structure by using nanostructured carbon (particles in the size range of approximately 2 to 10 nm) having hydrophilic properties (or composed of two components of the same size range having hydrophilic and hydrophobic properties respectively). In this case, the fine structure should occupy only a fraction of the pore volume of the coarse structure. For formation of a correspondingly structured precursor layer, the two precursor particle types mentioned in the foregoing either can be present already mixed together in one precursor solution (which is then applied on the substrate) or can be present in two separate solutions, which are then applied successively on the substrate. An aqueous electrolyte solution, for example, can then be sucked into the fine structure of a precursor layer structured in this way and can then be dried. The electrolyte solution can contain the catalyst salt.

In another preferred exemplary embodiment, the coarse structure can also be obtained by fibrous particles having sizes on the order of larger than or equal to 50 to 500 nm as well as hydrophobic surface properties, to form an interlaced or convoluted or reticular coarse structure. Such structures have high conductivity and form a highly porous coarse structure, which is eminently suitable for gas transport. Particles (having a size of 2 to 50 nm, for example) impregnated with precursor solutions of catalyst salts are then introduced into the interstices of the structures mentioned in the foregoing, or uncoated particles are introduced and then impregnated with precursor solution in a subsequent process step.

In conducting the inventive method, the resulting interlaced or convoluted or reticular structures then advantageously form the voids necessary for gas transport in the subsequent operation of a fuel cell. In this connection, it is advantageously found that no catalyst particles settle in the interior of these structures, but instead accretion of catalyst particles takes place only at the surface of such structures (or on the outer fibers bounding the structure) or on particles adjoining these structures.

Similar interlaced or convoluted or reticular structures having hydrophilic or otherwise altered surface properties can be formed especially for liquid transport by suitable process management or by corresponding selection of the composition of the precursor layer. Combinations of interlaced or convoluted or reticular structures having diverse surface properties can also be formed for specific structuring of the layer.

Graphite or carbon particles having a high graphite content have hydrophobic surface properties, are electrically more conductive and suffer less carbon degradation, and this can lead to significantly improved degradation properties.

As a general rule, the “usable” surface in the catalyst layer should be particularly large, and so nanostructured particles prove to be particularly effective components of the precursor layer within the scope of the present invention.

However, the addition of electrolytic filler materials such as PTFE and/or Nafion may reduce the size of this surface drastically, because then the chain length of the molecules is on the same order as the size of the particles. For this reason, therefore, it is preferable to work on the one hand with hydrophobic particles and on the other hand with hydrophilic particles, which possibly have already been soaked with Nafion.

For the hydrophilic part of the layer there can be used support particles (nanostructured carbon) soaked with Nafion or monomer or partly enveloped with monomer. The hydrophilic phase is advantageous in particular for regions conveying liquid. Within the scope of the present invention, it is advantageous to ensure an adequate ratio between the regions conveying liquid and gas.

In a further (second) structure-forming method variant of the present invention, it is provided that nonconductive particles also be admixed with the precursor layer, which particles, in a preferred improvement, are soaked, doped and/or coated at least partly with the electrolyte material.

This preferably relates to the hydrophilic part of the catalyst layer to be generated, and it has the advantage that catalyst cannot be deposited on a support particle enveloped by electrolyte but instead is always directed toward a conductive particle. In this way the probability is increased that gas contact also exists. After all, in the ideal case, the particles are in contact only at points. A disadvantage in this case, however, is that the catalyst particle concentration in the layer is lowered, and so the supported electrolyte particles preferably should be as small as possible, so that they can be optimally ordered in the structure. This structure-forming measure therefore begins expressly at the ion-conducting component of the layer. This method variant is also suitable in particular for high-temperature polymer electrolyte membrane fuel cells (HT-PEM), in which liquid electrolyte that impeded the formation of a well-defined three-phase zone has been used heretofore.

Accordingly, in a further preferred exemplary embodiment of the present invention, a layer of conductive larger support particles (in the range of approximately 50 to 500 nm or larger) can be used to form the coarse structure (with specific surface properties). These particles may be impregnated or soaked completely or partly with electrolyte and catalyst salts (inorganic salts, salts having organic ligands, or complexes), or they may be particles coated with catalyst particles (supported particles). As a further component of the precursor layer, conductive nanoparticles (having specific surface properties; mean size or diameter in the range of approximately 2 to 50 nm or larger) can be used in the inventive method to form the fine structure. These particles may be impregnated or soaked completely or partly with electrolyte and catalyst salts (inorganic salts, salts having organic ligands, or complexes), or they may be particles coated with catalyst particles (supported particles). And, finally, nonconductive nanoparticles (such as ceramic, zeolite, plastic) having specific surface properties may be additionally used. Here also an average particle size of approximately 2 to 50 nm proves to be advantageous. The nonconductive particles may in particular be impregnated, soaked, doped or coated completely or partly with electrolyte (in the form of monomers, for example) and catalyst salts (inorganic salts or salts having organic ligands or complexes), or they may be particles coated with catalyst particles (supported particles).

Either all of these components may be present in a single precursor solution, from which the precursor layer is then formed on a substrate, or the various components are successively applied in the form of separate solutions—repeatedly in thin layers if necessary—on the substrate. By virtue of the subsequent method step of electrochemical deposition, a catalyst layer structured in the inventive manner is then obtained, in which layer the catalyst particles are deposited in the best possible distribution over the fine and coarse structure.

The structured layer described hereinabove may therefore be generated, for example, by using the known supported catalyst particles (for example, from manufacturers such as Johnson Mattey (GB), BASF E-Tek Division (USA) or BASF Engelhardt (USA)).

In particular, however, it must be mentioned at this place that the foregoing statements on structure formation or on generation of specifically structured layers are independent of the actual process of electrochemical deposition and are also independent of the point in time at which the catalyst particles are generated (for example, generation of supported particles before or after production of the structured layer).

If—as explained in the foregoing—nonconductive support particles are impregnated with catalyst salt and introduced into the layer, the metal ions must migrate from the core of the particle to the surface in the direction of another particle during electrochemical deposition, in order to form a metal or catalyst particle. In this way the proportion of catalyst particles being deposited at an interface between electrolyte and electrical conductor without fuel-medium contact decreases greatly and the deposition at a three-phase interface comprising electrolyte, electrical conductor and medium increases.

Furthermore, within the scope of the present invention, the use of at least one chemical additive takes advantage of the fact that platinum and other metals (such as ruthenium) used as catalysts in fuel cells form chemical complexes with organic molecules that function as complexing agents (such as diazonium or similar cyclic organic molecules having special ligands, such as organic acid groups or (perfluorinated) polymer structures).

By the use of chemical additives suitable for structure formation within the scope of the third inventive method variant, it is possible in particular (a) to achieve particular additional properties of the layer (such as absorption capacity for water or electrolyte, stability of the layer, mechanical flexibility of the layer, etc.), (b) to generate particular spacings between precursor particles and (c) to generate particular spacings between catalyst particles to be deposited.

Furthermore, it must be noted that the nature and size of the molecules influence the rate of catalyst deposition, the nucleation rate (which determines the subsequent particle density of the catalyst material) and the growth of nuclei, which leads to the specific size of the catalyst particles. Thereby the electrochemical metal deposition can be controlled very accurately and catalyst particles can be deposited uniformly, at particular minimum spacings and in exactly defined sizes, in order to prevent disadvantageous agglomeration. Furthermore, both the precursor particles (carbon, etc.) and the subsequent catalyst particles can be stabilized by suitable additives, thus leading to greatly reduced degradation in fuel-cell operation.

The selective use of chemical additives therefore on the one hand assists bonding with catalyst salts in the precursor layer and on the other hand may also prove beneficial for impregnation of the support particles for control of the particle properties of the support particles and catalyst particles before, during and after the electrochemical deposition process.

And, finally, the fourth inventive method variant, with structure formation induced in the catalyst layer by gas formation or gas passage, depends on the knowledge that the electrochemical deposition does not necessarily take place at the aforesaid three-phase interface but firstly at a two-phase interface between electrode/substrate and electrolyte. Thus the subsequent drying of a solid electrolyte present in the layer or the subsequent coating with such a solid electrolyte may then again lead to unutilized catalyst.

Within the scope of the present invention, therefore, it is possible—in the fourth inventive method variant with specific structure formation for the catalyst layer—to take advantage of the fact that, for example, cathodic platinum deposition (H₂Pt[Cl₆]+4H⁺+4e⁻→Pt+6HCl) leads to the formation of hydrogen chloride (HCl). The HCl formed in this way usually dissolves completely in the water present in the electrolyte material, without gas evolution. Within the scope of the invention, however, it is now possible to ensure, by suitable adjustment of the ambient parameters (such as pressure, temperature, etc.), that the resulting HCl will pass into the gas phase.

Inactive catalyst material (because of coverage with electrolyte material) can therefore be prevented by the fact that a gas is generated in significant amounts during deposition and can then escape from the catalyst layer. In this way it is therefore also possible to create access to the gas phase automatically for catalyst particles that are otherwise covered, specifically by causing the solid electrolyte layer to burst due to the gas pressure. In addition or as an alternative to this, it is possible, following the electrochemical deposition, to generate hydrogen electrochemically (electrolysis) by controlled current supply, thus also leading advantageously to the situation in which the gas pressure in catalyst particles covered by solid electrolyte causes the solid electrolyte to burst. Furthermore, even controlled passage of gas through the layer during electrochemical deposition allows the operating environment (for example, the moisture content of the layer) to be optimally adjusted. The amount of gas to be generated or passed through according to the invention must therefore be regarded as significant, inasmuch as the inventive effect of structuring of the catalyst layer is achieved by creating an access to the gas phase, in the region of catalyst particles that are otherwise covered by electrolyte material.

The evolution of gaseous HCl can be promoted by using HCl-saturated water for the wetting (of the process atmosphere or of the solid electrolyte) that is necessary for electrochemical deposition. The evolution of gas can by assisted by the lowest possible process pressure and the highest possible process temperature, so that the electrolyte layer bursts in the affected regions or undesired reactions are suppressed by the gas pressure.

In general, potentiostatically controlled deposition may also be used to prevent catalyst deposition outside the three-phase zone. In particular, undesired hydrogen evolution can be suppressed in this way. Specifically, uncontrolled hydrogen evolution can lead in particular to chemical generation of catalyst particles outside the three-phase zone.

Furthermore, the structure of the electrode layer should already be completely formed if at all possible before deposition of the catalyst, and no post-treatment with further substances such as solid electrolyte or surface-altering substances (PTFE) should be applied within the catalyst layer.

Very generally, it must be noted that, for creation or preparation of the precursor layer, the catalyst in the form of catalyst salts can already be present in a solution that forms the precursor layer, or else that the precursor layer already applied on the substrate is impregnated only subsequently with a solution containing catalyst salts.

Depending on the particle types used or the combination thereof, or on the selected surface properties or the combination thereof, one of the following methods is preferably used for generation of the precursor layer:

a) Impregnating one or more or all particle types with a precursor solution containing catalyst salts by means of a suitable mixing technique (such as ultrasound, Ultra Turrax, extrusion, fluidized-bed technique, etc.), specifically before the particles are introduced into the structured layer. Following impregnation, one or more suitable dispersions are produced from these impregnated particles, from which dispersions the structured layer is then generated by applying the dispersion on the substrate.

b) Impregnating one or more or all particle types with a precursor solution containing catalyst salts after the structured layer has been generated by application of the non-impregnated particles, by applying the precursor solution specifically on the surface or in the layer (for example, by ink jet, spraying, screen printing, etc.) and wetting or impregnating the particles by penetration into the layer.

Impregnation of the particle layer can be achieved by bringing a material soaked with catalyst solution (such as nonwoven fabric, expanded material, other absorbent material, (micro)porous matrix, etc.) into contact with the particle layer, in which case the catalyst salt solution is introduced specifically into the layer by capillary forces, by diffusion or by specific application of external forces, so that a uniform layer thickness in the range up to 50 micrometers, advantageously up to 25 micrometers and particularly advantageously smaller than 10 micrometers can be produced by a reliable process. This specific impregnation can be performed before, immediately before or during the deposition process.

Alternatively, particles that have already been soaked with catalyst salt solution in a preceding step can be introduced into a prepared particle layer (conductive coarse structure), especially by taking advantage of (electro) physical forces (such as electrophoretic forces). The coarse structure can be specifically impregnated electrophoretically. Alternatively, impregnation of the precursor layer can also be achieved by application of the catalyst salt solution by ink jet technology. The depth of penetration of the catalyst salts into the previously generated coarse structure can be influenced by suitable choice of the amount of liquid applied and of the flow properties of the solution.

If necessary, the entire layer may also be soaked (even repeatedly) with a precursor solution containing catalyst salts, for example by dipping the entire gas-diffusion electrode into a precursor solution containing catalyst salts and then passing (also known as blowout) a controlled flow of gas through the layer, preferably using high gas flowrates under high pressure. Under these conditions, the hydrophobic regions in particular are freed of liquid, while the liquid can be discharged with more difficulty into the hydrophilic regions and remain there. By repeated soaking, blowout and drying, greatly differing but continuous regions having hydrophilic or hydrophobic properties are then obtained. If blowout is carried out at elevated temperature, the drying step can also be achieved simultaneously with blowout.

Within the scope of the present invention—independently of the other steps of the method—it can be advantageously provided that, to produce a gas-diffusion electrode (GDL as a substrate for the electrode layer), for example, the precursor layer and an electrolyte can be brought into contact temporarily (for electrochemical deposition) rather than permanently for the purpose of electrochemical deposition. In this connection, temporary contact is to be understood—depending on the duration of electrochemical deposition—as a time interval in the range of a few seconds (such as 2 to 10 seconds) up to several minutes (such as 30 minutes).

Solid bonding with the electrolyte used in the subsequent MEA can then be postponed until a later time, preferably without leading to losses or to coverage of catalyst. By this method of producing the gas-diffusion electrode, deposition does not have to take place in a format specified by the customer (and thus probably differing from one case to another) on the polymer electrolyte membrane, which is much more expensive than the diffusion layer. To the contrary, packaging (cutting the structured gas-diffusion electrodes to size and permanently bonding them with a solid electrolyte membrane of the desired format) can be achieved in a subsequent manufacturing step. In this way equipment and process costs can be reduced.

Furthermore, the preferred method for production of a gas-diffusion electrode by electrochemical deposition provides that temporary bonding between electrode material and the electrolyte is advantageously achieved with an (electrolyte) material that differs from the (electrolyte) material used subsequently for the MEA. In this way it is possible to use, for the electrochemical deposition, an electrolyte that optimally permits formation of the catalyst particles, and there is no need to resort to the membrane of the subsequent fuel cell, which membrane, for example, has been optimized in other respects. This was not possible in the prior art, in which the electrolyte membrane used in the subsequent fuel cell was always employed already for the purpose of electrochemical deposition with development of permanent contact. In this way, therefore, greater flexibility in the production of gas-diffusion electrodes is now achieved on the one hand, while—by choice of a suitable electrolyte—a higher quality of deposition during generation of the catalyst layer is achieved on the other hand.

It must therefore be expressly pointed out at this place that the foregoing concept of only temporary contact of a precursor layer with an electrolyte (which may differ from that in the subsequent fuel cell) for the purpose of electrochemical deposition of a catalyst has an inventive content that stands on its own merits and is independent of whether or not a structured catalyst layer is produced—as is provided within the scope of the present invention.

The temporary contact of the electrode structure with an electrolyte can be achieved, for example, by means of a solid electrolyte membrane, by means of a matrix filled with solid or liquid electrolytes or by means of a liquid electrolyte (such as sulfuric acid). If no liquid electrolyte is used, it is advantageous to introduce the layer during deposition in conjunction with a liquid (such as distilled water, sulfuric acid, etc.), in order to maintain constant wetting of the solid electrolyte and thus constant resistance of the electrolyte during deposition and in order to keep the operating temperature as constant as possible by the cooling effect of the liquid and thus to increase the quality of deposition.

Incidentally, it must be mentioned that comparable flexibility and optimization of the quality of deposition can also be achieved when the starting point for production of the catalyst layer is a precursor layer that has already been deposited (permanently) on an electrolyte, especially a polymer electrolyte membrane, as the substrate. In this case, a comparable concept for production of a membrane-electrode assembly may be to provide, for the purpose of electrochemical deposition, merely temporary contact with a substrate disposed opposite the membrane, so that it is not necessary to rely, for this purpose, on the GDL that will be used subsequently in a fuel cell, but instead it is possible to use a substrate made of different material.

And, finally, it must be mentioned that the present invention also comprises a catalyst layer produced in structured form in the inventive manner (possibly on a GDL as substrate) as well as a precursor solution or precursor layer that may be employed in this case and that has precursor particles specifically selected to be inhomogeneous. Moreover, the invention also relates to a membrane-electrode assembly (MEA) having an inventively structured catalyst layer as well as to a fuel cell equipped with such an MEA. It is self-evident that all comments pertaining to the inventive method are applicable in the same way to the cited layers, solutions or devices.

The invention will now be explained in more detail with reference to an exemplary embodiment of the invention illustrated schematically in the drawing.

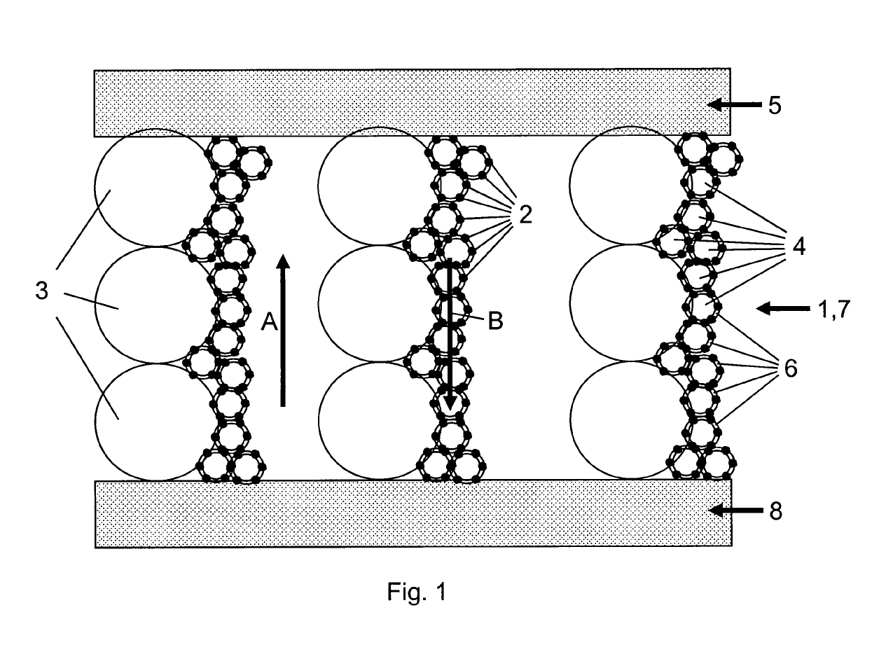

FIG. 1 shows, in a schematic and idealized diagram, a catalyst layer 1 for a methanol fuel cell, which was produced using an inventive method.

Inventively structured catalyst layer 1 contains a large number of catalyst particles 2 deposited electrochemically from a platinum salt and having sizes on the order of approximately 1.5 nm, wherein, before the electrochemical deposition, a precursor layer of larger conductive carbon particles 3 (mean diameter approximately 50 nm) and smaller conductive carbon particles 4 (mean diameter approximately 8 nm) was applied on gas-diffusion layer 5 acting as substrate by applying a precursor solution containing particles 3, 4 and then pressing the precursor layer onto the substrate. Larger particles 3, which advantageously have a high graphite content and therefore a hydrophobic surface, act to form a coarse structure, whereas smaller particles 4, which in the present case are soaked with electrolyte material 6 (Nafion in this case) and thus are almost completely covered, form a fine structure. Particles 3, 4 ensure the necessary electrical conductivity and form an electrode layer 7 (anode) of the MEA, which is shown only partly in FIG. 1. Electrolyte material 6 present in the layer (in the region of smaller particles 4) ensures the necessary ionic conductivity of the layer and imparts a hydrophilic surface condition to smaller particles 4. The interstices present in the coarse structure act as pores/channels and the like for removal of the products formed during fuel conversion toward the gas diffusion layer (see arrow A), whereas the fine structure forms ionically conductive paths that act to supply (in the direction of arrow B) the starting materials to solid electrolyte membrane 8 (in this case a polymer electrolyte membrane made from Nafion).

In an alternative variant of the inventive method, it may also be advantageously provided that smaller particles 4 soaked with electrolyte are composed of a nonconductive material.

What is claimed is:

1. A method for generating a catalyst layer (1) for fuel cells, for chemical reactors or for electrochemical reactors using a precursor layer, which contains a plurality of electrically conductive precursor particles (3, 4), wherein a catalyst (2) is electrochemically deposited, wherein the catalyst layer (1) is generated as a structured layer, by selecting the precursor particles (3, 4) to be specifically inhomogeneous with respect to at least one particle property.

2. A method according to claim 1, wherein the at least one inhomogeneously selected particle property is a surface property of the particle (3, 4), the particle material, the particle shape and/or the particle size.

3. A method for generating a catalyst layer (1) for fuel cells, for chemical reactors or for electrochemical reactors using a precursor layer, which contains a plurality of electrically conductive precursor particles (3), wherein a catalyst is electrochemically deposited, wherein the catalyst layer (1) is generated as a structured layer, by admixing nonconductive particles (4) with the precursor layer.

4. A method according to claim 3, wherein the nonconductive particles are soaked, doped and/or coated at least partly with the electrolyte material (6).

5. A method for generating a catalyst layer (1) for fuel cells, for chemical reactors or for electrochemical reactors using a precursor layer, which contains a plurality of electrically conductive precursor particles (3, 4), wherein a catalyst (2) is electrochemically deposited, wherein the catalyst layer (1) is generated as a structured layer, by admixing at least one chemical additive with the precursor layer.

6. A method for generating a catalyst layer (1) for fuel cells, for chemical reactors or for electrochemical reactors using a precursor layer, which contains a plurality of electrically conductive precursor particles (3, 4), wherein a catalyst (2) is electrochemically deposited, wherein the catalyst layer (1) is generated as a structured layer, by generating significant amounts of gas in the catalyst layer or passing such amounts therethrough before, during or after electrochemical deposition.

7. A method according to claim 1, wherein the catalyst in the form of catalyst salts is already present in a precursor solution that forms the precursor layer.

8. A method according to claim 1, wherein the precursor layer already applied on a substrate is subsequently impregnated with a solution containing catalyst salts.

9. A method according to claim 1, wherein the precursor layer is applied on a substrate, which forms a diffusion layer (5) for a fuel cell, a chemical reactor or an electrochemical reactor.

10. A method according to claim 1, wherein the precursor layer is brought into contact with an electrolyte (8) only temporarily for the purpose of electrochemical deposition.

11. A precursor layer for producing a catalyst layer by a method according to claim 1, comprising a plurality of electrically conductive precursor particles (3, 4), wherein the precursor particles are assembled to be specifically inhomogeneous with respect to at least one particle property or in that a chemical additive is admixed with the precursor layer.

12. A precursor layer according to claim 11, wherein the at least one inhomogeneously selected particle property is a surface property of the particle (3, 4), the particle material, the particle shape and/or the particle size.

13. A precursor layer according to claim 12, wherein a first partial amount (3) of the precursor particles (3, 4) has a hydrophobic surface and a second partial amount (4) of the precursor particles (3, 4) has a hydrophilic surface.

14. A precursor layer according to claim 11, wherein the precursor layer comprises conductive support particles having a size in the range of approximately 50 to approximately 500 nm or larger for formation of a coarse structure, conductive nanoparticles having a size of approximately 2 nm to approximately 50 nm or larger for formation of a fine structure and nonconductive nanoparticles, which can be completely or partly soaked, doped or coated with electrolyte material and/or catalyst material.

15. A precursor solution for producing a precursor layer according to claim 11, wherein the precursor particles (3, 4) are assembled to be specifically inhomogeneous with respect to at least one particle property.

16. A structured catalyst layer (1) for fuel cells, produced by a method according to claim 1.

17. An Membrane Electrode Assembly (MEA) for a fuel cell, comprising a solid electrolyte membrane (8) and two electrode layers (7), each of which is in contact with a diffusion layer (5), wherein at least one of the electrode layers (7) has a structured catalyst layer (1) produced by the method of claim 1.

18. A fuel cell having an MEA (1, 5, 7, 8) according to claim 17.
